(19) United States
(12) Patent Application Publication
(10) Pub. No.: US 2015/0329286 A1
(43) Pub. Date: Nov. 19, 2015

(54) FOAM INSULATION FOR CONTAINER WALL ELEMENTS

(71) Applicant: Uwe GEIB, Penzberg (DE)

(72) Inventor: Uwe GEIB, Penzberg (DE)

(21) Appl. No.: 14/389,373

(22) PCT Filed: Apr. 2, 2013
(86) PCT No.: PCT/EP2013/000972

§ 371 Date: Sep. 29, 2014

(30) Foreign Application Priority Data
Mar. 30, 2012 (DE) 10 2012 006 582.5

(51) Int. Cl. B65D 90/22; B65D 90/06; A62C 3/00

(52) U.S. Cl. CPC B65D 90/22; A62C 3/002; B65D 90/06

(57) ABSTRACT

The invention relates to insulation for a container wall element, a container wall of a large container in a thermal plant using such an element and a method for using such a container wall element in a container wall, wherein the container wall element comprises a fireproof material and a thermally insulating material, and an intermediate layer where appropriate. At least one fastening may be introduced into the thermally insulating material. The thermally insulating material can be formed from a glass or metal foam.

The invention relates to the insulation for large containers. In particular, the invention relates to an insulation of container wall elements of large containers and the use of these container wall elements in a container wall of a large container.

Current large containers—including plants in the field of melting technique, for example for glass melting—are furnaces or conveying sections of the melt, which are composed of selected fireproof materials. In the simplest case, they consist essentially of a base plate, the side walls and a vault. Those assemblies together enclose essentially the furnace chamber/melting chamber and hence the melt or, in case of thermal plants, the combustion chamber or the combustion way.

The invention can be applied to all types of large vessels like melting furnaces, pans, pots, etc., as well as for all meltable materials, for example, glass melts, metal melts, mineral melts, etc., as well as for single-component melts, multi-component melts, multi-layer melts, melting compounds, etc.; following, the preceding is referred to simply as furnace and melt. Likewise, the invention can be applied to other thermal plants, for example, in power plants or waste incineration plans in which the thermally processed charge is at least partially enclosed by an insulation or a container wall. However, the invention can also be applied for insulation of large vessels for very cold processes.

Parts of the furnace directly or indirectly enclosing the melt or the melting charge, preferably the fireproof parts or stones, are described by the term container wall elements which usually are stones. This means, for example, in case of a furnace, those parts which directly enclose the melt or an upper furnace, or in case of various sequentially located layers of parts, also those which are situated behind one another.

In case of application of an glass melting furnace, the entire glass melting furnace is subject to wear (corrosion/erosion), hence the glass melting furnace has a limited service life, the so called furnace campaign. A repair of worn parts or container wall elements without shutting down and cooling down is restricted and extends the furnace campaign of the furnace only insignificantly. After a few years, the entire melting furnace has to be renovated substantially completely and cost-intensively.

Hence, the objective of the invention is to provide an improved insulation for an enlarged furnace campaign and/or to reduce or eliminate a diffusion of gases or liquids, whereby the insulation shall be held flexibly.

The objective of the invention is achieved by a device and a method according to the features of the appended independent claims.

Container wall elements comprising a fireproof material are provided, whereby the fireproof material is at least on one side rigidly connected to with a thermally insulating material. A container wall of the fireproof material having a thermally insulating material reduces the heat loss through a wall of the melting furnace. When using the invention in cold systems, a container wall having such a setup hence reduces a cold loss. Both times, advantageously, the energy consumption is reduced. By rigidly applying a thermally insulating material to the fireproof material of the container wall element, the handling during the assembly of a container is facilitated accordingly. The container wall elements can be used as wall elements in the side walls, in the base, as intermediate wall or also in the cover.

The thermally insulating material may be any material suitable for this purpose. Furthermore, the insulating material may have the property of being gas diffusion proof. Also, the insulating material may comprise a mechanical strength such that at least one fastening can be inserted in the insulating material. Contrarily, the at least one fastening may be joined to the fireproof material by an interposed structure which is mechanically resistant and the fireproof material may be insulated by a thermally insulating material having a low or no mechanical load capacity. In particular, a preferable thermally insulating material may be glass foams or metal foams. The fireproof material can either be directly provided with these foams or the foams can be applied to the fireproof material.

When applying the thermally insulating material, either the at least one fastening can be inserted into the already existing thermally insulating material or the thermally insulating material can be produced around the at least one fastening. It is also conceivable, that the thermally insulating material itself forms a fastening, for example as a form element for a positive connection. The at least one fastening may be of any suitable shape and contains, for example, threaded bolts or form elements for increasing flexibility of the container wall element, for example, a ball head. The at least one fastening can be attached to the thermally insulating material by a positive connection, a non-positive connection or an adhesive bond. The at least one fastening can be used for holding and feed transfer to the container wall element at a melting furnace having walls which can be pushed through, as disclosed in EP 2011001574. The fastening can also be directly inserted into the fireproof material and can then be able to penetrate the thermally insulating material. In principle, all fastenings which permit force and/or moment transmission into and out of a container wall element are suitable.

In case of using a foam as a thermally insulating material, the at least one fastening can be incorporated into the foam during the production of the foam on the fireproof material. It may be suitable that the at least one fastening comprises anchorages which then are incorporated into the thermally insulating material, i.e. the foam is foamed on the fireproof material in a way that the fastenings “grow in” the foam. Presuming a sufficient mechanical strength of the thermally insulating material, for example a thread can be provided in the thermally insulating material, if required by means of an interposing threaded insert.

It is also possible to apply the insulating material to the fireproof material 1 in form of a solid element—with or without fastenings. Hereby, it is possible, that the thermally insulating material already is in the desired shape for the fused casted fireproof material to be casted and the two materials are only assembled.

An intermediate layer may be arranged between the fireproof material and the thermally insulating material. This intermediate layer can be created by the direct application of the thermally insulating material to the fireproof material, for example, a glass layer when applying glass foam. Also, a separate layer can be applied, for example, for connecting and/or sealing the fireproof material and the thermally insulating material. The intermediate layer may increase the impermeability relative to gas diffusion through the various layers or the intermediate material may provide the impermeability.

The individual layers of the container wall element can comprise various extensions, such that adjacent container wall elements can engage with each other or overlap each other. The overlap may have a positive influence on the stability and impermeability of an assembly of container wall elements. The individual layers forming the container wall element may have different thicknesses.

The individual layers of the container wall element may comprise channels and/or connections for the passage of a medium. The container wall element can additionally be cooled or heated by these channels and/or connections. This may be advantageous when heating or cooling the entire plant. In particular, the liquid material from the melting process or of another process or of an upstream process (e.g. liquid glass, liquid metal) can be lead through the channels. This material can completely or partially provide the energy for the melting process. For instance, the channels in the individual container wall elements can be connected with each other by means of a sleeve system.

In such a sleeve system, one end of the channel contained in the container is provided as a sleeve and the other end is extended as a shoulder, whereby the shoulder fits into the sleeve of the following container wall element. The connection between the container wall elements must be designed in a way that the impermeability of the channel connection between the container wall elements is ensured also if the adjacent container wall elements have a different orientation. Here, suitable sealing, a suitable geometry of the sleeve connection (e.g. ball/socket shape) or flexible parts like a bellow or a hinge can be used. Additionally, the sleeve portion of the container wall element can be provided with sensors, e.g. for detecting temperature and pressure conditions on the connections and for using this data for controlling/regulating the entire plant.

The connection of the channels of individual container wall elements can also be dulled, whereby suitable sealing, having sensors if required, is set between the container wall elements. It is also possible to connect the channels with a dulled connection by applying a sufficiently high pressure to the container wall elements and hence providing impermeability. The sealing can be provided as pressure elements. The channels can be provided in a way that a controlling function is initiated by means of a movement of individual elements. For example, other channels are opened by an at least partially offset movement. Hereby, a flowing fluid can be redirected or conducted into several or different channels—also when lead over or transferred by adjacent parts. Likewise, throttling the flow velocity is conceivable by a targeted offset which reduces the passage channel in this position. This system can be used for controlling/regulating the energy supply in the melt, as well as for heat dissipation of upstream processes to at least partially lead the process heat of various, at least two successively following processes for at least supporting another process energetically by a management of the various, at least two successively following processes. This can also be performed simultaneously as well as in any combination thereof. The same as for heating applies for cooling.

The container wall elements can be provided with sensors, e.g. for gathering pressure and temperature conditions and possible further (measurement) data in relation to the container wall element. The gained data can be used advantageously for controlling/regulating the entire plant. The sensors can be arranged in or on the thermally insulating material as well as in or on the fireproof material as well as in or on the intermediate layer. The sensors can also be incorporated in the thermally isolating layer of the container wall element. The sensors may be disposable sensors which may be activated or lost when reaching a predetermined parameter or the sensors may be sensors whose data can be queried.

Advantageously, a container wall, for example a side wall, can be assembled substantially by a plurality of the container wall elements which are movable relative to each other and relative to their position in space. Thus, a melting furnace having adjustable walls which can be pushed through can be provided.

The individual container wall elements of the container wall can be arranged with an offset relative to each other in a way that by pushing-though the individual container wall elements, adjacent container wall elements may not have the same feeding position. This is advantageous when removing the stones which are pushed through because it can be advantageously avoided that multiple container wall elements have to be removed at the same time.

The individual container wall elements of the container wall can be provided with connecting elements between each other in a way that a feeding force can be reliably transmitted from one container wall element to the other container wall element. This connection can also be provided by an actuator like a hydraulic drive or a spindle drive. Thus, the individual container wall elements can be moved relative to each other and in relation to each other, or pressure condition can be changed. For example, the actuators can be attached to the at least one fastening of each of the container wall elements to transmit force to each of the at least one fastening. For example, if a container base is stationary and the side wall comprises container wall elements which can be pushed through, increased friction may occur between the stationary base and the movable container wall elements. Thus, base elements can be anchored of fixed in a way that the base elements stay in position when the container wall elements are pushed through even if melt gets between the stationary and the moving parts of the container wall. Hereby, it is not mere holding, but tensile and compressive forces can be used to displace the stones relative to their height (into the melt or out of the melt) for manipulating the current to provide a recess adjustable in its height, for example in the base. Thus, a variable homogenization zone can be provided by lifting and lowering of multiple base elements by means of an adjustability in height.

Between the individual container wall elements of the container wall, sensors can be arranged for detecting pressure and temperature conditions relative to the container wall or of a section of it. Advantageously, the sensors' data can be used for controlling/regulating the entire plant, in particular, for controlling/regulating the actuators which on the one hand cause feeding of the container wall elements and on the other hand for the actuators which can be arranged between the individual container wall elements for adjusting or at least temporarily overlapping an arrangement of individual elements, partial sections or entire sections with each other, also for multiple times if necessary.

The container wall elements can be reprocessed and reused after being pushed through the container wall and being worn. On the one hand, the worn area can be processed and flattened and, e.g., by applying a new fireproof material. Hence the thermally insulating material on the container wall element can be reused. On the other hand, the thermally insulating material can be removed and applied to another side of the container wall element. As an advantage, the container wall elements can be reused for multiple times and hence reduce costs.

In application of a glass melting furnace, a layer of thermally insulating material consisting of glass foam, having a fastening if necessary, can be directly applied to a glass layer resulting from the use of a removed container wall element on the side of the removed container wall element facing the melt. With sufficient thickness of the fireproof material, an application of new fireproof material is not necessary. Otherwise, additional fireproof material can be applied.

The pushing of the individual container wall elements through the container wall is provided as a continuous process which can be controlled/regulated in dependence on data acquired by the sensors. In the process of pushing-through, an unused, new or reprocessed container wall element is applied to the container wall and moved into a feeding direction. A used container wall element is removed on an end of the passage way and can be reprocessed. The container wall elements can be pushed through the container wall in form of single elements, partial sections or as an entire wall. The container wall elements can be arranged in an auxiliary frame or be assembled to form an assembly of container wall elements. This assembly can also be provided adjustable relative to its position in space (e.g. slope etc.). An according disclosure can be found in EP 2009007101. Likewise, the individual sequences of container wall elements and the assemblies of container wall elements can be moved independently of each other with respect to feeding direction, speed and position in space. The container wall elements can be movably mounted in a wall in a way that, relative to their position in the passage way within the wall of the thermal plant, the container wall elements overlap if the diameter of the plant is small and move from the overlap to a position adjacent to each other, in which the container wall elements merely comprise few overlapping if the diameter is bigger.

The features mentioned above can be combined in any order with each other and, if above mentioned in a context, do not necessarily only appear in this context of an embodiment of the invention. It is not necessary for all advantages mentioned to be present in a given embodiment.

### FIGURES

Showing:

FIG. 1 a sectional view through a section of a container wall element with exemplary, different fastenings in a thermally insulating material, where the fastenings are inserted in the thermally insulating material.

FIG. 2 a sectional view through a section of a container wall element with exemplary, different forms of fastenings in the thermally insulating material, where the fastenings are inserted in the thermally insulating material by postprocessing or assembly.

FIG. 3 a sectional view through a section of two assembled container wall elements which are connected on the inserted fastenings by means of a connecting element.

FIG. 4 a sectional view through a section of two assembled container wall elements assembled to each other which are assembled on the inserted fastenings, the connecting element and the actuator arranged therebetween, an hydraulic cylinder, such that the container wall elements are adjustable in their distance to each other.

### DETAILED DESCRIPTION

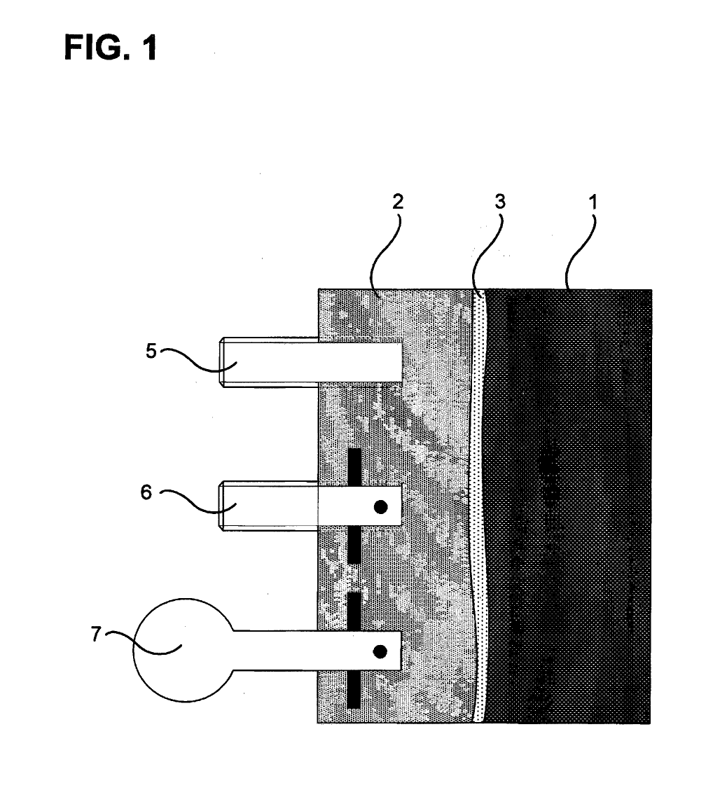

In FIG. 1, as an embodiment, the container wall element 1, 2, 3 is shown, containing the fireproof material 1, an intermediate layer 3 and the thermally insulating material 2. Wherein the thermally insulating material 2 provides an insulating effect against thermal influences and the intermediate layer 3 and/or the thermally insulating material 2 provide a barrier against diffusion or penetration of gases or fluids both through the thermally insulating material 2 in direction of the fireproof material 1 and in the opposite direction.

Both a fused cast material and a material cast in any other way with or without a subsequent post treatment, like drying or burning, are understood as a fireproof material 1, for example a ceramic or a metal which comprises fireproof properties. This also includes materials of the specified type with one or multiple sheathing, layers, covers or any conceivable type of surface coating or surface treatment.

The thermally insulating material 2 is preferably solid, whereby a glass foam or metal foam is also considered as solid. The decisive factor is an insulating effect against thermal influences and/or diffusion resistance and preferably the possibility of inserting, assembling or attaching various types of fastening elements 5, 6, 7, 8, 9, 10, 11a, 11b.

Preferably, the intermediate layer 3 or 4 is an adhesive bond of any kind between the fireproof material 1 and the thermally insulating material 2, for example gluing or cementation; a frictional or a positive connection of any kind is also conceivable. The intermediate layer can also be created by means of the connection of the fireproof material 1 with the thermally insulating material 2.

In application of glass as an intermediate layer 3, a previously used container wall element, having worn fireproof material 1, which has already been in a glass area of the melting furnace can be used such that, as an intermediate layer 3, a glass layer situated on the fireproof material 1, glass can be used and the thermally insulating material 2 is applied on this, see FIG. 1. In this case, the previously used fireproof material 1 can be reprocessed and renewed.

Of course, this does not only apply to the field of glass but also to any materials adherent on the fireproof material 1 which was in contact with these materials.

The application of an intermediate layer 3 or 4 can also be performed on a new fireproof material 1 to provide a connection between the fireproof material 1 and the thermally insulating material 2.

Both the thermally insulating material 2 and the fireproof material 1 can be used as a base for applying the respective counter layer 1, 2 for producing the container wall element. Normally, this depends on the material properties. Applying for example glass foam as a thermally insulating material 2 on a fused coat fireproof material 1 is relatively simple and, if necessary, can be performed immediately after e.g. casting the fireproof material 1. Likewise, the fireproof material 1 can be applied to an already finished thermally insulating material 2.

FIG. 1 shows a sectional view of the container wall element 1, 2, 3 with multiple different fastenings inserted in thermally insulating material 2. An inserted fastening is a threaded bolt 5 which is in direct contact with the thermally insulating material 2. Another inserted fastening is a threaded bolt having anchorages 6. On the threaded bolt with anchorages 6, anchorages which provide an increased stability and strength of the threaded bolt are provided at the end of the threaded bolt which is inserted in the thermally insulating material 2. Yet another fastening is a cast-in ball pin with anchorages 7. The cast-in ball pin with anchorages 7 comprises the anchorages previously processed on its end which is inserted in the thermally insulating material. Furthermore, on its other end, the cast-in ball pin with anchorages 7 comprises a ball pin which provides the container wall element 1, 2, 3 with a higher flexibility.

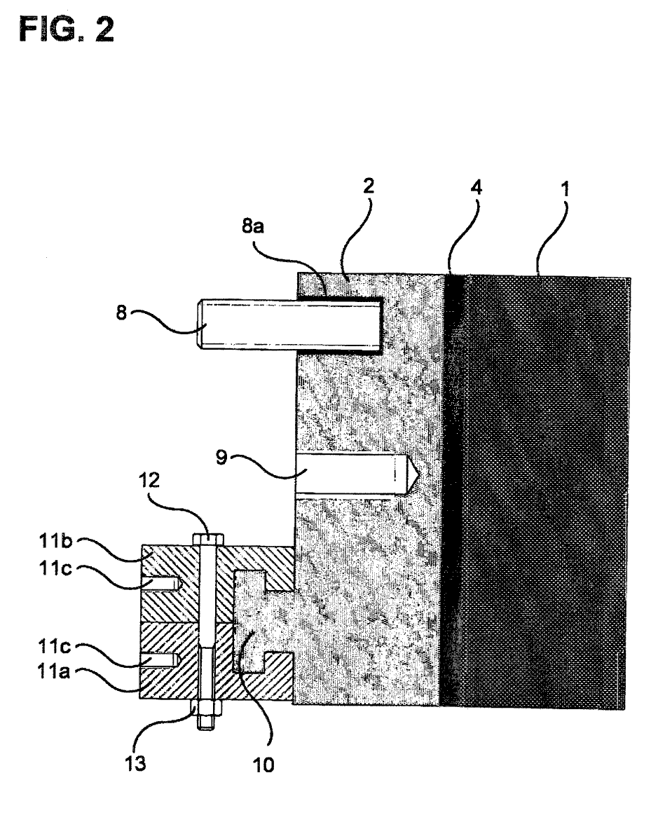

FIG. 2 shows another container wall element 1, 2, 4 with additional examples of possible fastenings. At this container wall element 1, 2, 4, the fireproof material 1 and the thermally insulating material 2 are connected by means of an adhesion-promoting intermediate layer 4 which may also provide sealing. A fastening inserted in the thermally insulating material 2 in the form of a threaded bolt 8 is inserted in the thermally insulating material 2 by means of an adhesion-promoting material 8a. Another fastening 9 in the form of a threaded hole 9 is inserted in the thermally insulating material 2. For transferring the forces necessary for pushing the container wall element 1, 2, 4 through the container wall a certain mechanical strength of the thermally insulating material 2 is required. At this position, a known threaded insert can be used for providing a thread in the thermally insulating material 2.

As further shown in FIG. 2, a fastening can be provided by means of a form element 10 formed by the thermally insulating material 2. Two fastening parts 11a and 11b engage positively connected with the form element 10. The two fastening parts 11a and 11b comprise threaded holes 11c. The two fastening parts 11a and 11b are connected by means of a screw 12 with a nut 13. Likewise, one or more fastening parts and other embodiments can be hold by means of a non-positive connection on a partial section of the thermally insulating material 2.

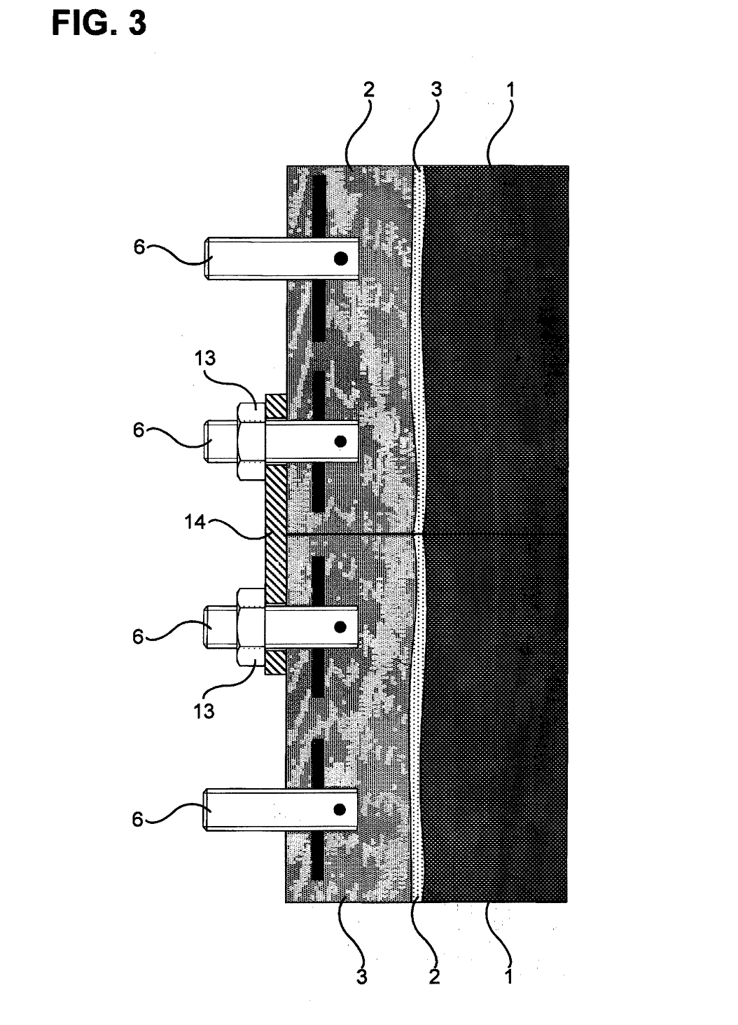

FIG. 3 shows a connection between two container wall elements 1, 2, 3 by means of a connecting element 14. The two container wall elements 1, 2, 3 comprise fastenings in the form of threaded bolts with anchorages 6. The connecting element 14 is mounted to each of the threaded bolts with anchorages 6 on each of the container wall elements 1, 2, 3 by means of a nut 13. Thus, a feeding force can e.g. be transferred from one container wall element 1, 2, 3 to the other container wall element 1, 2, 3.

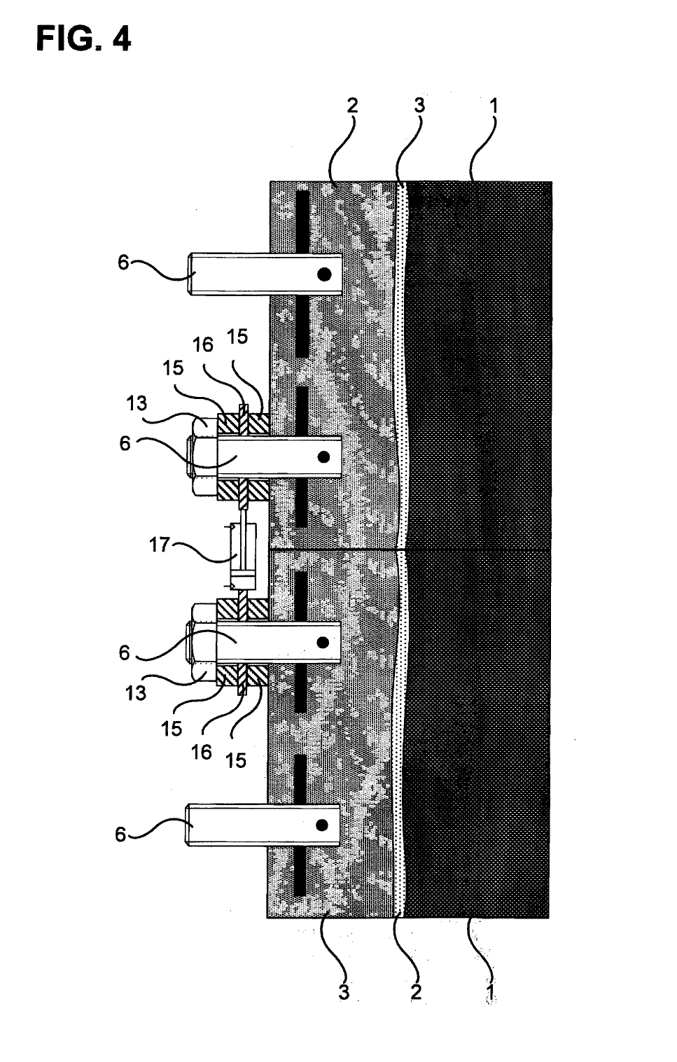

FIG. 4 shows a connection between two container wall elements 1, 2, 3 by means of a hydraulic cylinder 17. The two container wall elements 1, 2, 3 comprise fastenings in the form of threaded bolts with anchorages 6. The hydraulic cylinder 17 is connected to a threaded bolt with anchorages 6 of each of the container wall elements 1, 2, 3 each by means of two washers 15, one transferring element 16, and a nut 13. Thus, a distance between the two container wall elements 1, 2, 3 by means of the hydraulic cylinder 17 can be adjusted and the pressure condition between the two container wall elements 1, 2, 3 can be influenced.

1. A container wall element made of a fireproof material (1), wherein the container wall element is provided with a thermally insulating material (2) at least on one side.

2. The container wall element according to claim 1, wherein the thermally insulating material (2) is gas diffusion proof.

3. The container wall element according to claim 1, wherein at least one intermediate layer (3; 4) is arranged between the fireproof material (1) and the thermally insulating material (2), wherein the intermediate layer connects the layer of the thermally insulating material (2) to the fireproof material (1).

4. The container wall element according to claim 1, wherein the thermally insulating material (2) is provided with at least one fastening element.

5. The container wall element according to claim 4, wherein the at least one fastening element (5, 6, 7, 8, 9, 10, 11a, 11b) is inserted in the thermally insulating material (2).

6. The container wall element according to claim 4, wherein the at least one fastening element (10) is formed at least partially by the thermally insulating material (2).

7. The container wall element according to claim 1, wherein, for the construction of large containers, the container wall element contains at least one wall which can be pushed through.

8. The container wall element according to claim 1, wherein the various layers of the container wall element comprise various extensions.

9. The container wall element according to claim 1, wherein the container wall element is provided with sensors.

10. The container wall element according to claim 1, wherein the container wall element comprises channels for the passage of a medium.

11. The container wall element according to claim 1, wherein the thermally insulating material (2) is metal foam or glass foam.

12. A container wall containing a plurality of container wall elements according to claim 1, wherein the individual container wall elements are arranged movable relative to each other.

13. The container wall according to claim 12, wherein the container wall elements are arranged with an offset relative to at least one adjacent container wall element.

14. The container wall according to one of the claim 12, wherein at least two container wall elements are assembled.

15. The container wall according to one of the claim 12, wherein actuators are arranged between the container wall elements.

16. The container wall according to one of the claim 12, wherein sensors are arranged between the container wall elements.

17. The container wall according to one of the claim 12, wherein the container wall elements can be moved relative to each other by the at least one fastening.

18. The container wall according to one of the claim 12, wherein the container wall elements are rotated after use and are provided with a new intermediate layer (3; 4) and/or thermally insulating material (2), whereby the thermally insulating material (2) at least partially comprises a fastening.

19. A method for the operation of a large container with at least two container wall elements according to claim 1 in a container wall according to claim 12 containing the steps of:
Inserting a first combination element in the container wall;
Pushing-through of the first container wall element within the container wall, following a second container wall element located upstream in the feeding direction;
Removing each of the container wall elements located upstream in the feeding direction at the end of a passage way of the container wall;
wherein by means of the method, a continuous circle of removal and insertion of container wall elements is maintained (with providing a continuously running process in the container) and the removed container wall elements are processed prior to insertion.

20. The method according to claim 19, wherein the processing of the removed container wall elements containing one of the steps of:
Processing the fireproof material (1) and applying additional fireproof material (1); or
Removing the thermally insulating material (2) to expose the fireproof material (1) and applying new thermally insulating material (2) with at least one fastening on the container wall element.
